(19) United States
(12) Patent Application Publication
(10) Pub. No.: US 2024/0188589 A1
(43) Pub. Date: Jun. 13, 2024

(54) PALATABILITY ENHANCER (PALATANT) COMPOSITION FOR USE IN EDIBLE PET PRODUCTS

(71) Applicant: Natural Polymer International Corporation, Plano, TX (US)

(72) Inventors: Lingxiang Sun, Plano, TX (US); Steven Ho, Plano, TX (US)

(21) Appl. No.: 18/222,541

(22) Filed: Jul. 17, 2023

Related U.S. Application Data
(60) Provisional application No. 63/390,192, filed on Jul. 18, 2022.

(51) Int. Cl. A23K 20/142

(52) U.S. Cl. CPC A23K 20/142

(57) ABSTRACT

A palatability enhancer composition for edible pet products comprises Cysteine and Arginine, at 0.1%-10.0% by weight; and Lysine at 0.1%-10.0% by weight. The palatability enhancer may also include at least one of the following: Alanine, Glutamine, Aspartic acid, Glycine, Phenylalanine, Isoleucine, Histidine, Vitamin B1, and a reducing sugar, at 0.1%-10.0% by weight.

### CROSS REFERENCE TO RELATED APPLICATIONS

This application claims priority to U.S. Provisional Application No. 63/390,192 filed Jul. 18, 2022, the disclosure of which is incorporated herein by this reference.

### BACKGROUND

The pet industry is a thriving and rapidly growing sector that encompasses a wide range of businesses and services related to pets. The pet industry has witnessed consistent growth over the years. According to various reports, the global pet industry was valued at over $223 billion in 2020, and it is projected to continue growing in the coming years. The industry has shown resilience even during economic downturns, as pet owners tend to prioritize their pets' well-being.

The pet food segment holds a significant portion of the pet industry. Pet owners are increasingly concerned about the quality and nutritional value of the food they provide to their pets. Pet food were estimated to make up the largest share of the market in the United States starting from 2021. Pet food can be generally segmented into dry, wet (canned or moist), semi-moist, treats (or snacks), and raw/frozen/refrigerated dog and cat foods. Complete and balanced pet food products are formulated to be the single source of nutrition for a pet. Most pets are sustained mainly through feeding of a reduced range of commercial products and a limited number of production batches for a prolonged amount of time. This has led to a rise in demand for premium and specialized pet food options, including organic, natural, and grain-free products. The market also includes a variety of pet treats and snacks, which is another important segment of pet food, even though not necessarily so well balanced nutritionally, treats are generally more highly flavored, or have a special chewy texture, aiming at providing an enjoyable experience for the animal and its owner.

Palatability can be defined as pleasure an individual receives in association with eating a particular food, or simply how much the individual (or animal) likes the smell and taste of a certain food. Palatability in pet food refers to the taste, aroma, and overall appeal of the food to pets. It is a measure of how much a pet enjoys and is attracted to a particular food product. A highly palatable pet food is one that is appetizing and appealing to pets, encouraging them to cat and enjoy their meals. It is one of the most important aspects in edible pet products. Palatability can be improved by adding a palatability enhancer, also known as a palatant. It is specifically designed to enhance the taste and aroma of the food, making pet food more attractive to pets, encouraging them to consume an adequate amount of food and enjoy their meals. These palatants can be added in a variety of ways depending on what it is going to be applied on. For dry pet foods, palatants are usually added as a top coating while pumps of fat and liquid palatant are sprayed onto wet food. For pet treats, palatants are usually added into the treat itself or added as a topcoat after extrusion.

There are many factors that contribute to palatability acceptance in pets. The most important being smell since dogs and cats both have highly developed olfactory acuity. This is more important in cats than compared to dogs. Cats tend to be slow eaters, and tend to linger around their food longer, this allows more opportunities for their olfactive neurons to be triggered. While dogs are quick caters, leaving a limited time for their olfactive neurons to be triggered. The second important factor is taste due to its connection to the olfactory senses. Dogs have more taste buds compared to cats, and can detect flavors such as sour, bitterness, salty, sweet, and umami. Cats on the other hand can detect similar flavors except for sweet which is completely undetectable. Factors like texture or mouth feel, in many cases can also contribute to the palatability of the food. Dogs tend to dislike larger sized kibble because they spend more time chewing. This factor is especially important for cats which are more sensitive to the size and shape of their kibble. Cats tend to reject foods with sharp edges due to its uncomfortable mouth feel.

Palatants play a crucial role in enhancing the palatability of pet food. They are specifically formulated and added to pet food to improve the taste, aroma, and overall appeal of the food to pets. Palatants are designed to enhance the taste of pet food. They add flavors that pets find appealing, such as meat, poultry, fish, or vegetable flavors. By intensifying and improving the taste of the food, palatants make it more enjoyable for pets to cat. Palatants also contribute to the aroma of pet food. They are selected and formulated to enhance the natural smells of the ingredients used in the food. The appealing aroma helps stimulate a pet's appetite and makes the food more enticing. Palatants can help mask any undesirable flavors or odors that may be present in certain ingredients or during the manufacturing process. By covering up or neutralizing these less desirable tastes, palatants make the overall food more palatable for pets. Palatants enhance the overall sensory experience of eating for pets. The improved taste and aroma make the meal more enjoyable, creating a positive association with the food and reinforcing regular and consistent eating habits.

Palatability tests are conducted by professionals such as pet food manufacturers to assess the acceptance and preferences of pets towards different food formulations. These tests help determine the palatability of a particular product and guide the development of pet foods that are more appealing to pets. Palatability tests typically involve using a group of animals as test subjects. Tests are conducted in a controlled environment to minimize external influences that may affect the results. The test subjects are usually kept in individual test chambers or cages to ensure that each animal's response is assessed independently. The consumption of each test sample is carefully measured to determine the amount of food consumed by each animal. This can be done by weighing the food before and after presentation to the animal or by using specialized feeding equipment that records intake. Test subjects may also be presented with multiple food options simultaneously to evaluate their preference rankings. This allows for a comparison of preferences among different samples or formulations. The data collected during the palatability tests are analyzed to determine the relative palatability of the samples. Statistical analysis is often performed to identify any significant differences in preference between the test groups. Palatability tests recognize that individual animals may have different preferences and responses. This is taken into account when evaluating the results, as the goal is to develop a product that appeals to a broad range of pets.

### SUMMARY

The described invention comprises an edible pet product palatability enhancer using Cysteine and Arginine, at 0.1%-10.0%, and Lysine at 0.1%-10.0%, meat and/or veggie hydrolysate at 50.0%-99.6% by weight that provides maximized palatability at moderate application level when used internally or topically.

In a first aspect, the invention provides a food composition that enhance the performance of edible pet products, where the use of Cysteine and Arginine, at 0.1%-10.0% each, and Lysine at 0.1%-10.0% by weight and other amino acids combined, will provide rich and diversified aroma that significantly enhance the palatability, where Cysteine will contribute meat/caramel types of aroma, Arginine will contribute bread/butter/caramel types of aroma, Lysine will contribute bread/caramel types of aroma. The meat and/or veggie hydrolysate is either directly purchased or hydrolyzed in-house, where the proteins are hydrolyzed a certain degree where 90% under 5,000-10,000 Dalton. The amino acids profile of described hydrolysate comprises: 2.0%-8.0% of Aspartic acid, 1.0%-4.0% of Threonine, 1.0%-5.0% of Serine, 3.0%-15.0% of Glutamic Acid, 1.5%-5.0% of Glycine, 1.0%-5.0% of Alanine, 0.05%-5.0% of Cystine, 1.0%-5.0% of Valine, 0.05%-5.0% of Methionine, 0.5%-4.0% of Isoleucine, 1.0%-5.0% of Leucine, 0.5%-4.0% of Tyrosine, 1.0%-5.0% of Phenylalanine, 1.0%-10.0% of Lysine, 0.5%-4.0% of Histidine, 1.0%-5.0% of Arginine, on dry matter basis. The enhancer described comprises protein at 5.0%-40.0%, fat at 0.5%-20.0%, ash at 0.01%-5.0%, moisture at 50.0%-80.0%. The preferred range of addition of described enhancer in edible pet products is about 0.5%-20.0%.

In another aspect, the invention comprises thermal processing condition of 210-300 degree Fahrenheit for 20-100 minutes, for the completion of series Maillard reactions. Vitamin B1 at 0.1%-10.0% is introduced as processing aids for the optimization of performance. Reducing sugars of Xylose and Fructose at 0.5%-10.0% each by weight are introduced for the completion of Maillard reactions as well as performance optimization. Mixed Tocopherols as antioxidant maybe added to the described composition during/after the thermal process.

The described invention can be included with any additional ingredients which provide adequate nutrition, and/or animal health benefits, and/or structural strength for the forming of edible pet products. The described composition along with/without additional ingredients may be formed through injection molding processes and/or cold and hot extrusion process to form edible pet products. The described composition may also be applied topically—also referred to as Coating in pet industry, to deposit the palatability enhancer onto the surface of edible products by spraying, dusting, etc.

The described invention will significantly improve the palatability performance of edible pet products, comparing to major leading brands in the market. The invention will be described with the following examples.

### BRIEF DESCRIPTION OF THE DRAWINGS

FIG. 1 shows an embodiment wherein no palatant is added to a standardized basal formula.

FIG. 2 shows an embodiment wherein a palatant is added to a standardized basal formula.

FIG. 3 shows another embodiment wherein a palatant of the invention is compared with a commercial palatant in a standardized basal formula.

FIG. 4 shows another embodiment wherein a palatant of the invention is compared with a commercial palatant in a standardized basal formula.

FIG. 5 shows yet another embodiment wherein a palatant of the invention is compared with another commercial palatant in a standardized basal formula.

### DETAILED DESCRIPTION

The acceptance palatability trials are conducted by professional animal farms registered with USDA under the Animal Welfare Act. Twenty pets (dogs/cats) with identifications are used for the test. The pets receive normal diets on regular basis and at least two hours prior to the trials. The trial duration is two days. The pets have access to the treats not to exceed thirty minutes. Amount consumed and first choice are documented for each pet. The following animal behaviors might also be documented, if needed or applicable: chewed, sniffed, licked, played with, picked up, dropped, lost interest, no interest, and time to finish.

The comparison palatability trials are conducted by professional animal farms registered with USDA under the Animal Welfare Act, using the industry standard two bowl comparison test. Twenty pets (dogs/cats) with identifications are used for the test. The pets receive normal diets on regular basis and at least two hours prior to the trials. The trial duration is two days with treat placement switched each day to avoid handedness and bias. The pets have access to the treats until they finished the equivalent of one treat, but not to exceed thirty minutes. One treat of each variable is provided to each pet each day. Amount consumed and first choice are documented for each pet. The following animal behaviors might also be documented, if needed or applicable: first approach, chewed, sniffed, licked, played with, picked up, dropped, lost interest, no interest, and time to finish. A Chi-squared test (Chi² test) will be conducted for data analysis to determine the preference whether two groups of products are chosen equally or not.

### Example 1

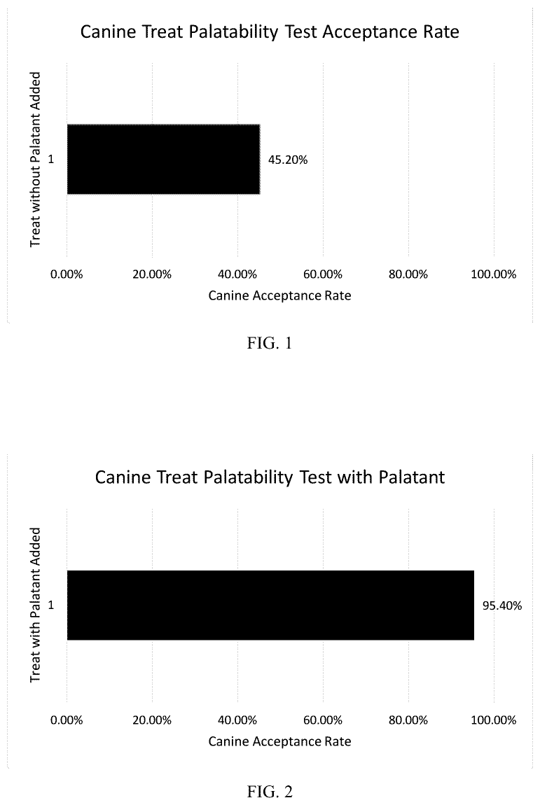

The FIG. 1 and FIG. 2 illustrate the palatability acceptance difference between the use of palatant and the use without. The carrier being a standardized basal formula, where it comprises 20.0%-50.0% rice flour, 5.0%-20.0% vegetable glycerin, 5.0%-20.0% water, by weight, and necessary amount of nutrient and processing additives. The material compositions are processed with twin screw hot extruders, ranging from 75 degree Centigrade to 140 degree Centigrade.

FIG. 1 reflects the situation where no palatant is added.

FIG. 2 reflects the situation where palatant is added at 0.5%-5.0% by weight.

Basing on the results from acceptance palatability test, over a 2-day period the products with palatant (FIG. 1) added showed a roughly twice the consumption rate comparing to the products without palatant (FIG. 2) among testing dogs. It also indicated the products without palatant performed poorly, with less than 50%, yet products with palatant performed good with more than 95% acceptance rate.

### Example 2

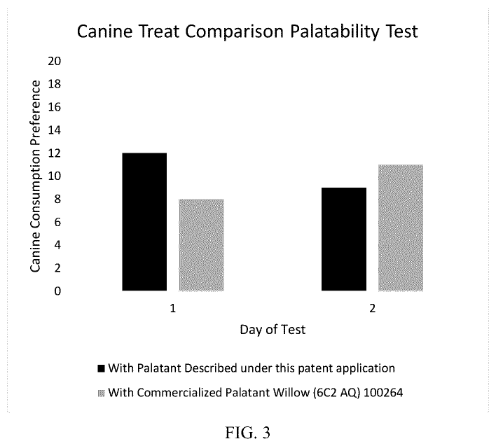

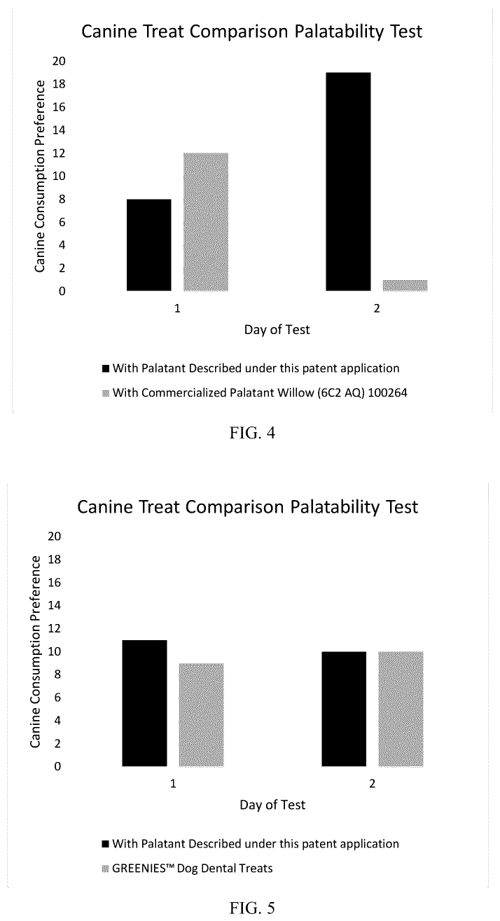

The FIG. 3 and FIG. 4 illustrate the comparison palatability difference between the use of the palatant described under this patent application and a commercialized palatant, Willow (6C2 AQ) 100264, from company AFB International. The carrier being a standardized basal formula, where it comprises 20.0%-50.0% rice flour, 5.0%-20.0% vegetable glycerin, 5.0%-20.0% water, by weight, and necessary amount of nutrient and processing additives. The material compositions are processed with twin screw hot extruders, ranging from 75 degree Centigrade to 140 degree Centigrade.

In the test shown in FIG. 3, the palatant described under this patent application and a commercialized palatant Willow (6C2 AQ) 100264 were at an inclusion ratio of 0.7:1; in the test shown in FIG. 4, the palatant described under this patent application and a commercialized palatant, Willow (6C2 AQ) 100264 were at an inclusion ratio of 1:1.

Table. 1 and 2 reflects the summary of Chi-squared tests regarding the comparison palatability tests among products with palatant described under this patent application and a commercialized palatant Willow (6C2 AQ) 100264.

TABLE 1
Daily Preference Count

| Day | Treat A | Treat B | P of Chi² | Significant |
|---|---|---|---|---|
| 1 | 12 | 8 | 0.3711 | NO |
| 2 | 9 | 11 | 0.6547 | NO |

TABLE 2
Daily Preference Count

| Day | Treat A | Treat B | P of Chi² | Significant |
|---|---|---|---|---|
| 1 | 8 | 12 | 0.3711 | NO |
| 2 | 19 | 1 | 0.0001 | YES |

Basing on the results from comparison palatability test, the palatant described under this patent application has similar performance comparing to a commercialized palatant Willow (6C2 AQ) 100264, when used at an even lower percentage in product (0.7:1). Moreover, when used at the same percentage (1:1), the palatant described under this patent outperforms with statistically meaningful results.

### Example 3

The FIG. 5 illustrates the comparison palatability difference between the use of the palatant described under this patent application and GREENIES™ Dog Dental Treats, one of the most reputable leading brands in the US dental treat market. The carrier being a standardized basal formula, where it comprises 20.0%-50.0% rice flour, 5.0%-20.0% vegetable glycerin, 5.0%-20.0% water, by weight, and necessary amount of nutrient and processing additives. The palatant described was at 0.5%-20.0% of the total weight. The material compositions are processed with twin screw hot extruders, ranging from 75 degree Centigrade to 140 degree Centigrade. The comparison products of that leading brand are purchased directly through retail stores.

FIG. 5 reflects the consumption ratio/preference of products with palatant described under this patent application (colored Orange) and GREENIES™ Dog Dental Treats (colored Blue) among test dogs.

Table. 3 reflects the summary of Chi-squared test regarding the comparison palatability test among products with palatant described under this patent application and GREENIES™ Dog Dental Treats among test dogs.

TABLE 3
Daily Preference Count

| Day | Treat A | Treat B | P of Chi² | Significant |
|---|---|---|---|---|
| 1 | 11 | 9 | 0.6547 | NO |
| 2 | 10 | 10 | 1.0000 | NO |

Basing on the results from comparison palatability test, the palatant described under this patent application has similar performance comparing to GREENIES™ Dog Dental Treats, one of the most reputable leading brands in the US dental treat market, with statistically parity result.

Although the use of the invention has been described in details with examples and illustrations, it is not limited to the specific material combination nor manufacturing processes disclosed hereinabove, and that many modifications, equivalents, and alternatives are intended to be included within the scope of the claims.

It should be understood that various changes and modifications to the presently preferred embodiments described herein will be apparent to those skilled in the art. Such changes and modifications can be made without departing from the spirit and scope of the present subject and without diminishing its intended advantages. It is therefore intended that such changes and modifications be covered by the appended claims.

1. A composition that increases palatability of an edible pet product, comprising cysteine at 0.1%-10% by weight;
arginine at 0.1%-10% by weight;
a meat hydrolysate at 50.0%-99.9% by weight;
one or more amino acids other than cysteine or arginine each at 0.1%-10.0% by weight; and
one or more processing aids each at 0.1%-10.0% by weight.

2. The composition of claim 1, wherein the one or more amino acids other than cysteine or arginine are selected from a group of alanine, glutamine, aspartic acid, glycine, phenylalanine, isoleucine, and histidine.

3. The composition of claim 1, wherein the one or more processing aids are selected from a group of vitamin B1, xylose, fructose, and mixed tocopherols.

4. The composition of claim 1, wherein the meat hydrolysate is originated from chicken, pork, lamb, fish, or insects.

5. A composition that increases palatability of an edible pet product, comprising
cysteine at 0.1%-10% by weight;
arginine at 0.1%-10% by weight;
a veggie hydrolysate at 50.0%-99.9% by weight;
one or more amino acids other than cysteine or arginine each at 0.1%-10.0% by weight; and
one or more processing aids each at 0.1%-10.0% by weight.

6. The composition of claim 5, wherein the one or more amino acids other than cysteine or arginine are selected from a group of alanine, glutamine, aspartic acid, glycine, phenylalanine, isoleucine, and histidine.

7. The composition of claim 5, wherein the one or more processing aids are selected from a group of vitamin B1, xylose, fructose, and mixed tocopherols.

8. The composition of claim 5, wherein the veggie hydrolysate is originated from soy or dried yeast.

9. A method of making a composition that increases palatability of an edible pet product comprising steps of,
making a mixture comprising cysteine at 0.1%-10% by weight; arginine at 0.1%-10% by weight; a meat hydrolysate at 50.0%-99.9% by weight; one or more amino acids other than cysteine or
arginine each at 0.1%-10.0% by weight; and one or more processing aids each at 0.1%-10.0% by weight;
acidify the mixture to a pH in a range of about 2.0 and 7.0; and
treat the mixture at about 210 to 300 degree Fahrenheit for about 20 to 100 minutes.

10. The method of claim 9, wherein the one or more amino acids other than cysteine or arginine are selected from a group of alanine, glutamine, aspartic acid, glycine, phenylalanine, isoleucine, and histidine.

11. The method of claim 9, wherein the one or more processing aids are selected from a group of vitamin B1, xylose, fructose, and mixed tocopherols.

12. The method of claim 9, wherein the meat hydrolysate is originated from chicken, pork, lamb, fish, or insects.

13. The method of claim 9, wherein the mixture comprises protein at 5.0%-40.0%, fat at 5.0%-20.0%, ash at 0.01%-5.0%, and moisture at 50.0%-80.0%.

14. The method of claim 9, wherein the mixture deposits 0.5%-20.0% by weight in the edible pet product.

15. A method of making a composition that increases palatability of an edible pet product comprising steps of,
making a mixture comprising cysteine at 0.1%-10% by weight; arginine at 0.1%-10% by weight; a veggie hydrolysate at 50.0%-99.9% by weight; one or more amino acids other than cysteine or arginine each at 0.1%-10.0% by weight; and one or more processing aids each at 0.1%-10.0% by weight;
acidify the mixture to a pH in a range of about 2.0 and 7.0; and
treat the mixture at about 210 to 300 degree Fahrenheit for about 20 to 100 minute

16. The method of claim 15, wherein the one or more amino acids other than cysteine or arginine are selected from a group of alanine, glutamine, aspartic acid, glycine, phenylalanine, isoleucine, and histidine.

17. The method of claim 15, wherein the one or more processing aids are selected from a group of vitamin B1, xylose, fructose, and mixed tocopherols.

18. The method of claim 15, wherein the veggie hydrolysate is originated from soy or dried yeast.

19. The method of claim 15, wherein the mixture comprises protein at 5.0%-40.0%, fat at 5.0%-20.0%, ash at 0.01%-5.0%, and moisture at 50.0%-80.0%.

20. The method of claim 15, wherein the mixture deposits 0.5%-20.0% by weight in the edible pet product.
